(19) United States
(12) Patent Application Publication
(10) Pub. No.: US 2008/0106554 A1
(43) Pub. Date: May 8, 2008

(54) ORGANIC LIGHT EMITTING DIODE PIXEL CIRCUIT AND BRIGHTNESS CONTROL METHOD THEREOF

(75) Inventors: Tze-chien Tsai, Hsin-Chu City (TW); Li-wei Shih, Hsin-Chu City (TW)

Correspondence Address: MADSON & AUSTIN, 15 WEST SOUTH TEMPLE, SUITE 900, SALT LAKE CITY, UT, 84101, US

(73) Assignee: AU Optronics Corp., Hsin-Chu (TW)

(21) Appl. No.: 11/768,161

(22) Filed: Jun. 25, 2007

(30) Foreign Application Priority Data
Jun. 29, 2006 (TW) 095123685

(51) Int. Cl. G09G 5/10; G09G 3/30

(52) U.S. Cl. 345/690; 345/76

(57) ABSTRACT

An organic light emitting diode (OLED) pixel circuit and a brightness control method thereof. When the voltage across the source and drain of the driving transistor is fixed, the brightness of the OLED achieves a predetermined brightness for a specific gray level (e.g. white level) as being controlled by the control voltage applied to the gate of the driving transistor.

### TECHNICAL FIELD OF THE INVENTION

The present invention relates to a pixel circuit for use in a display device, and more particularly, to an organic light emitting diode (OLED) pixel circuit and brightness control method thereof.

### BACKGROUND OF THE INVENTION

FIG. 1 is a circuit diagram showing a conventional OLED pixel circuit. As shown, the OLED pixel circuit includes a first transistor 12, a storage capacitor 14, a second transistor 16 and an OLED 18. The second transistor 16, which can be a p-channel transistor, is used as a driving transistor driving the OLED 18. The second transistor 16 has its source connected to a voltage source supplying voltage V_{DD}, and its drain connected to an anode of the OLED 18. The OLED 18 has its cathode connected to a voltage source supplying a low voltage V_{SS}.

The second transistor (i.e., a driving transistor) 16 has its gate connected to an auxiliary voltage source of the V_{DD} voltage source via the storage capacitor 14. In addition, pixel data “data” are supplied to the gate of the second transistor 16 via data lines (not shown). The supply of the pixel data “data” to the gate of the second transistor 18 is controlled by the first transistor 12. The first transistor 12, which can be an n-channel transistor, acts as a switch. A gate of the first transistor 12 receives a scan signal “scan” from a scan line (not shown), and turns on/off according to the scan signal “scan” so as to control the supply of the pixel data “data” to the gate of the second transistor 16.

In displaying, the scan signal (“scan”) provided by the scan line is high, thereby turns on the first transistor 12 accordingly. Under such a condition, the pixel data (“data”) transmitted by the data line charges the storage capacitor 14. Then the second transistor 16 is driven by a voltage corresponding to the pixel data “data” to make a current flow through the OLED 18, thereby causing the OLED 18 to emit light.

Theoretically, for the same pixel data, that is, under the same gray level, the brightness of the respective pixels should be the same. For example, the OLEDs in different pixel circuits should emit the same brightness to display a white level. In other words, the brightness for white level of the OLEDs in the respective pixel circuits should be identical. However, OLED brightness is substantially proportional to the current flowing through the OLED, and the current is affected by the characteristics of the driving transistor 16 (the second transistor in FIG. 1). The current may be varied under the same V_{DD} and V_{SS}. Accordingly, the brightness of the respective pixel circuits for the same gray level may be different due to the variation in the driving transistor characteristics.

To overcome such a problem, a voltage difference across the driving transistor is altered to adjust the brightness of the OLED, according to prior art. In some applications, V_{SS} is fixed and V_{DD} is adjusted so that the current flowing through the OLED is varied and the OLED brightness is accordingly adjusted. For example, if V_{SS} is fixed as −9V, the adjustable range of V_{DD} is +3V to +5V, then the design for a circuit board has to satisfy the requirements of 5V. Hence, the power consumption is increased since the potential difference becomes 14V from 12V. This also results in non-uniformity of the circuit specifications. Briefly, in order to maintain the OLEDs of the respective pixel circuits to have the same brightness under an identical gray level, V_{DD} for the respective pixel circuits must be different.

### SUMMARY OF THE INVENTION

The present invention provides a novel pixel circuit brightness control method which can adjust the OLED brightness for a specific gray level (e.g. white level) as desired without adjusting the magnitudes of V_{DD} and V_{SS}.

An objective of the present invention is to provide a method for controlling brightness of an OLED pixel circuit. By using the method, OLED brightness of the pixel circuit is adjusted so that the OLED achieves a predetermined brightness for a specific gray level without varying voltages supplied to the circuit.

Another objective of the present invention is to provide an OLED pixel circuit. The OLED of the circuit is controlled to achieve a predetermined brightness for a specific gray level without changing voltage supplied to the circuit.

In accordance with the present invention, the method for controlling brightness of an OLED pixel circuit includes setting a control voltage, and applying the control voltage to a driving transistor of the pixel circuit to control brightness of an OLED, wherein the control voltage can be a basic voltage of a gamma circuit. The setting of the control voltage can be achieved by adjusting a resistance at the lowest level voltage end of the gamma circuit.

In accordance with the present invention, the OLED pixel circuit includes a switch for controlling input of a data signal; and OLED; a driving transistor for driving the OLED and a voltage controller. The voltage controller determines a control voltage, and applies the control voltage to the driving transistor to drive the OLED to emit a predetermined brightness for a specific gray level. The voltage controller can be implemented by a gamma circuit. For example, a basic voltage (the lowest level voltage) of the gamma circuit is controlled to make the OLED brightness achieve a predetermined value for a white level. The basic voltage of the gamma circuit can be controlled by adjusting a resistance at the lowest voltage end.

### BRIEF DESCRIPTION OF THE DRAWINGS

FIG. 1 is a schematic circuit diagram showing a conventional pixel circuit;

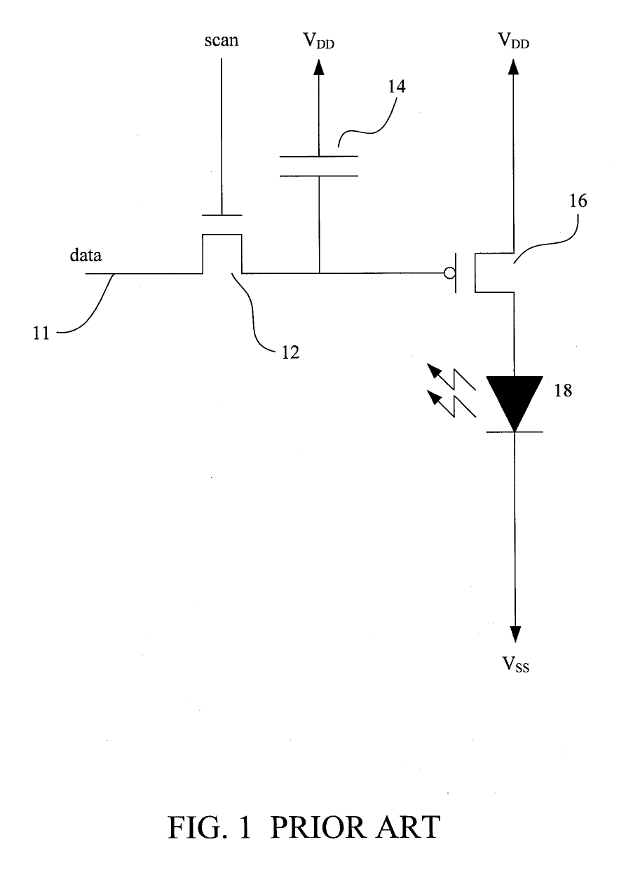

FIG. 2 is a schematic circuit diagram showing a pixel circuit in accordance with the present invention;

FIG. 3 is a schematic circuit diagram showing a voltage controller of the pixel circuit in FIG. 2; and

FIG. 4 is a schematic illustration showing that a gamma curve shifts as the basic voltage changes.

### DETAILED DESCRIPTION OF THE INVENTION

The present invention will be further described in details in conjunction with the accompanying drawings.

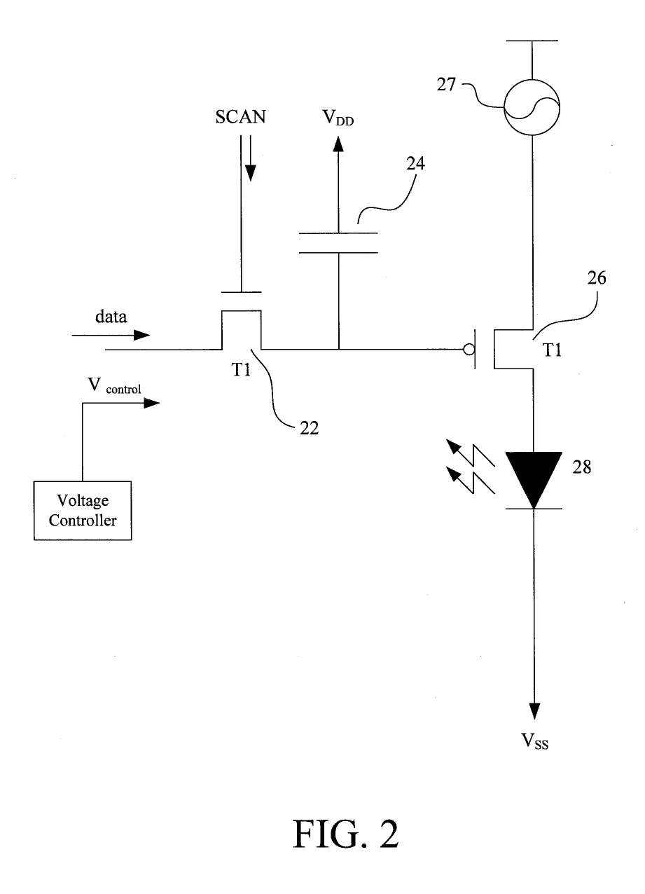

FIG. 2 is a schematic circuit diagram showing a pixel circuit in accordance with one embodiment of the present invention. As shown, the pixel circuit of the embodiment includes a switching transistor 22, a storage capacitor 24, a driving transistor 26, a voltage source 27 and an OLED 28. The driving transistor 26 has a source thereof connected to the voltage source 27, which provides voltage V_{DD}, and a drain thereof connected to an anode of the OLED 28. The OLED 28 has its cathode connected to a low V_{SS} voltage source. The pixel circuit in accordance with the present invention further includes a voltage controller 30, which applies a control voltage V_{control} to the gate of the driving transistor 26 to control a driving current so as to determine the brightness of the OLED. In accordance with an embodiment of the present invention, the voltage controller 30 controls a voltage of a pixel data “data” as the control voltage V_{control}, the details will be further described later.

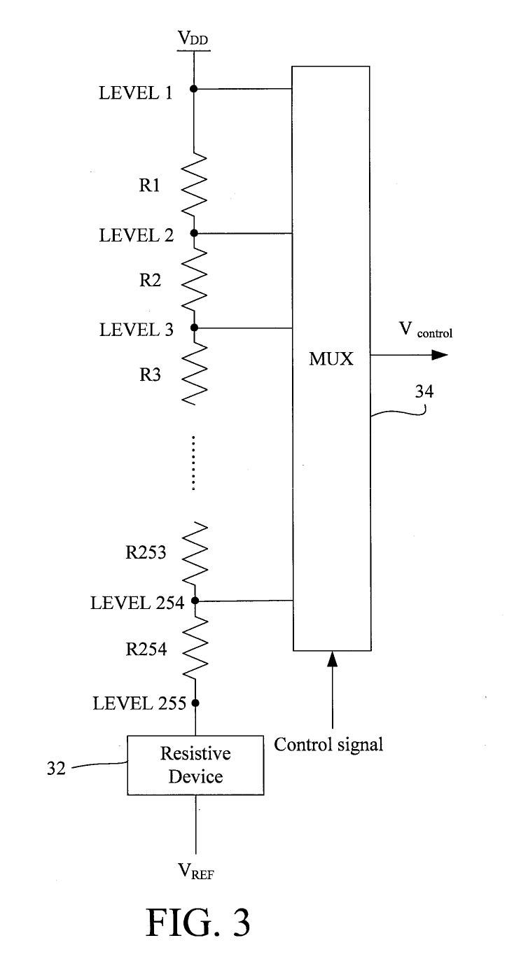

FIG. 3 shows a gray level adjusting circuit, which is also referred to as a gamma circuit. The gamma circuit comprises a number of resistors R1, R2, . . . , R253, and R254 connected in series and electrically connected to the voltage V_{DD}. Voltages output from respective nodes of the gamma circuit are different, so as to cause the OLED brightness to be different. In the embodiment of the present invention, the voltage controller 30 is implemented by the gamma circuit shown in FIG. 3. In the circuit, the voltage at LEVEL 255 is the lowest level voltage. When the lowest level voltage is applied to the gate of the driving transistor 26, the OLED brightness is at the maximum. Such a gray level (LEVEL 255) is referred to as a “white level”, and the lowest level voltage is referred to as a white level voltage. According to the present invention, a resistive device 32 is provided between the last resistor R254 and a reference voltage V_{REF}. The resistive device 32 provides a resistance to determine the basic voltage (i.e. the white level voltage) applied to the respective resistors connected in series, so as to determine the brightness of the OLED in the respective levels. The gamma circuit further has a multiplexer 34 which outputs one of the voltage outputs from the respective nodes according to a control signal or control signals provided thereto. That is, the gamma circuit provides a control voltage according to the control signal provided to the multiplexer 34.

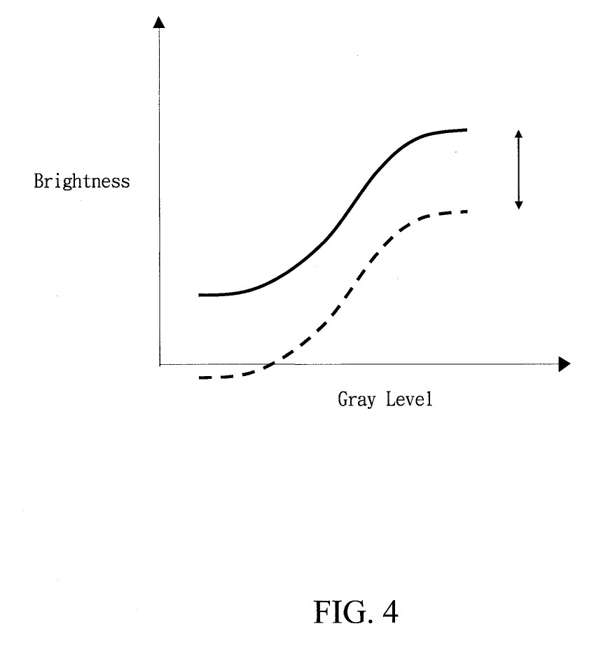

In accordance with the embodiment of the present invention, the basic voltage of the gamma circuit (gray level circuit) is adjusted by the resistive device 32. It is noted that the profile of gamma curve is not changed but there is offset in the vertical-axis direction (brightness) thereof. As shown in FIG. 4, the gamma curve shifts upward or downward as the basic voltage varies, however, the curvature of the curve is not changed. That is, the differences between gray levels after adjustment are still the same. However, the voltages corresponding to the respective gray levels are adjusted so that the brightness of each gray level is tuned.

As described above, the basic voltage of the gamma circuit is adjusted by the resistance provided by the resistive device 32, so that the voltages of the respective levels of the gamma circuit can be changed. For example, the lowest level voltage is changed as the resistance varies. When the lowest level voltage (white voltage) is different, the brightness that the OLED in the pixel circuit achieves in the white level is also changed. Accordingly, the white level brightness of the OLED can be adjusted by static setting or dynamic adjusting the resistance of the resistive device 32. That is, the resistance of the resistive device can be of a fixed proper value so that the control voltage of a fixed level is applied to the pixel circuit; alternatively, the resistance of the resistive device can be adjustable so that the control voltage of an adjustable level is applied to the pixel circuit. Thus, the brightness of the OLEDs of the respective pixel circuits can be uniform even if the electric characteristics of the driving transistors in the respective pixel circuits are different.

In practice, the resistance provided by the resistive device 32 is preferably a variable. The resistive device 32 can comprise a variable resistor. Alternatively, the device can be implemented by a combination of a plurality of fixed resistors and/or switches. The device may also comprise a transistor. In the preferred embodiment, the pixel circuit is in the white level state. That is, the pixel data indicates to display white level, and provides the white level voltage to the pixel circuit through the gamma circuit. By adjusting the resistance of the resistive device 32, the white level brightness of the OLED 28 in the pixel circuit is able to achieve a predetermined brightness. By doing so, the brightness non-uniformity of the OLEDs caused by the difference among the driving transistors of the respective pixel circuits can be reduced.

While the preferred embodiment of the present invention has been illustrated and described in details, various modifications and alterations can be made by persons skilled in this art. The embodiment of the present invention is therefore described in an illustrative but not in a restrictive sense. It is intended that the present invention should not be limited to the particular forms as illustrated, and that all modifications and alterations which maintain the spirit and realm of the present invention are within the scope as defined in the appended claims.

What is claimed is:

1. A method for controlling brightness of an organic light emitting diode (OLED) of an OLED pixel circuit, said OLED pixel circuit having an input terminal for receiving pixel data, a switch for receiving a scan signal to control the receipt of the pixel data, a driving transistor having a control terminal and for driving the OLED in response to the pixel data, and a gamma circuit for setting a control voltage designated to a specific gray level of the pixel data, said method comprising:
(a) determining the control voltage designated to the specific gray level of the pixel data by adjusting a specific level of voltage of the gamma circuit to shift a gamma curve of the gamma circuit; and
(b) applying the control voltage to the control terminal of the driving transistor of the OLED pixel circuit so that the brightness of the OLED at the specific gray level achieves a predetermined value.

2. The method of claim 1, wherein the specific level of voltage is the lowest level voltage of the gamma circuit.

3. The method of claim 2, wherein the lowest level voltage of the gamma circuit is adjusted by determining a resistance at the lowest level end of the gamma circuit.

4. The method of claim 1, wherein the control voltage is determined to be a fixed level in the step of determining the control voltage for the specific gray level.

5. The method of claim 1, wherein the voltage is determined to be a variable level in the step of determining the control voltage for the specific gray level.

6. The method of claim 1, wherein the specific gray level is a white level.

7. An organic light emitting diode (OLED) pixel circuit comprising:
a switch for controlling input of a data signal;
a voltage source;
a driving transistor having a first terminal electrically coupled to the voltage source, a second terminal electrically coupled to an OLED, and a control terminal electrically coupled to the switch; and
a voltage controller including a gamma circuit for providing a control voltage for a specific gray level to the control terminal of the driving transistor, the control voltage being adjusted by determining a specific level of voltage of the gamma circuit to shift a gamma curve thereof and applying the determined specific level of voltage of the gamma circuit to the control terminal so that the brightness of the OLED at the specific gray level achieves a predetermined value.

8. The circuit of claim 7, wherein the specific level of voltage is the lowest level voltage of the gamma circuit.

9. The circuit of claim 8, wherein the gamma circuit comprises a resistive device electrically coupled to a lowest level voltage end thereof, and the resistive device provides a resistance to determine the lowest level voltage of the gamma circuit.

10. The circuit of claim 9, wherein the resistance of the resistive device is fixed.

11. The circuit of claim 9, wherein the resistance of the resistive device is variable.

12. The circuit of claim 11, wherein the resistive device comprises a variable resistor.

13. The circuit of claim 11, wherein the resistive device comprises a combination of plural fixed resistors.

14. The circuit of claim 11, wherein the resistive device comprises a transistor.

15. The circuit of claim 7, wherein the voltage controller determines the control voltage according to characteristics of the driving transistor.
